(19) United States
(12) Patent Application Publication
(10) Pub. No.: US 2009/0056668 A1
(43) Pub. Date: Mar. 5, 2009

(54) Acoustic Side Cover for an Engine

(75) Inventor: Gary J. Hazelton, White Lake, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 11/972,169

(22) Filed: Jan. 10, 2008

Related U.S. Application Data
(60) Provisional application No. 60/970,010, filed on Sep. 5, 2007.

(51) Int. Cl. F02B 77/13; E04B 1/82

(52) U.S. Cl. 123/198 E; 181/284

(57) ABSTRACT

An apparatus for reducing engine noise includes a side cover configured to operatively connect to a side of an engine block. The side cover has a first layer configured to be adjacent to an outer surface of the side of the engine block. The first layer is made of a first acoustic-absorbing material. The side cover also has a second layer configured to be adjacent to the first layer opposite the engine block. The second layer is a second substantially rigid material establishing an acoustic barrier and is configured to operatively support at least one engine component such as an electrical or fluid line, such as by an integrally formed fastener or channel.

### CROSS-REFERENCE TO RELATED APPLICATIONS

This application claims the benefit of U.S. Provisional Application No. 60/970,010, filed Sep. 5, 2007, which is hereby incorporated by reference in its entirety.

### TECHNICAL FIELD

The invention relates to a side cover for an engine providing an acoustic barrier.

### BACKGROUND OF THE INVENTION

Engines generate a substantial amount of noise. For example, diesel engines can be especially loud during a cold start. Minimizing engine noise helps to create a more pleasant driving experience. Additionally, an acoustically-treated engine may have higher combustion noise levels to improve fuel economy, emissions, power and torque, while still maintaining pleasing NVH (noise, vibration and harshness) characteristics. Any noise reduction strategy should be balanced against the increased cost and the potential reduction in fuel economy associated with added components, their additional mass, and any additional processing and assembly steps.

### SUMMARY OF THE INVENTION

An apparatus for reducing engine noise includes a side cover configured to operatively connect to a side of an engine block. The cover has a first layer configured to be adjacent to the engine block. The first layer is made of a first acoustic-absorbing material. The cover also has a second layer configured to be adjacent to the first layer opposite the engine block. The second layer is a second substantially rigid material that acts as an acoustic barrier and is configured to operatively support at least one engine component such as an electrical or fluid line. The second layer may have an integrally-formed fastener or channel used to provide such support. By configuring the side cover to support engine components, the engine block may not require as many bosses that are typically used for mounting brackets for hoses, wiring harnesses, etc. Overall mass is thus reduced, with an associated increase in fuel economy, as the side cover is less dense than a boss formed by the engine block.

The second layer may be configured with an integrally-formed fastener or mounting bracket for supporting an engine conduit such as a wiring harness, an electrical line, or a fluid line or pipe. Alternatively or in addition, the second layer may be formed with a boss configured to secure a mounting bracket or fastener for an engine conduit. In at least some embodiments, the second layer may include an integrally-formed channel for supporting and guiding an engine conduit, such as a hydraulic or electrical line that press-fits within the channel. Both the first and second layers may also be formed to define apertures that align with bosses extending from the engine block so that the bosses extend through the apertures when the side cover is connected to the engine block, allowing access to the bosses.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration in perspective fragmentary, partially exploded view of a partially assembled engine having a first embodiment of a multi-layer side cover;

FIG. 2 is a schematic illustration in perspective fragmentary view of the engine of FIG. 1 with the side cover and other engine components assembled with an engine block;

FIG. 3 is a schematic illustration in side view of one of the fasteners connected to a fastener boss in the side cover of FIG. 2 for supporting an engine conduit; and

FIG. 4 is a schematic illustration in perspective, fragmentary view of a second embodiment of an engine with a second embodiment of a multi-layer side cover assembled with an engine block and having an integral conduit support channel and integral conduit fasteners.

### DESCRIPTION OF THE PREFERRED EMBODIMENTS

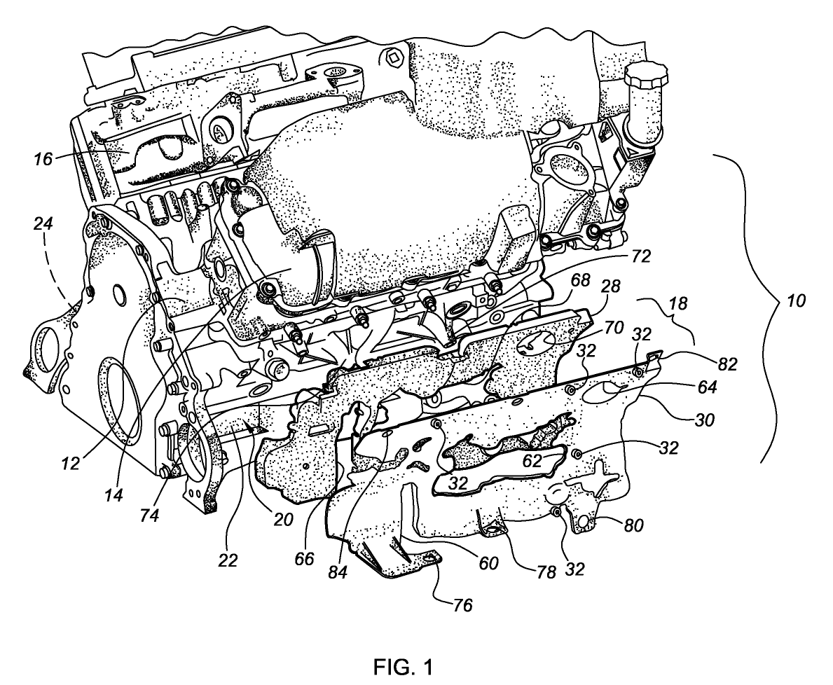

Referring to the drawings, wherein like reference numbers refer to like components, FIG. 1 shows a V-8 diesel engine 10 having an engine block 12 that defines two opposing rows of cylinder bores (not visible, but well understood by those skilled in the art), slanting inward from beneath cylinder head covers 14, 16, as is well understood by those skilled in the art. It should be understood that other types of engines may be used within the scope of the invention as well. However, diesel engines may especially benefit from the noise reduction function of the side covers 18 described herein.

A first side cover 18 is shown in exploded view adjacent an outer surface 20 of a side 22 of the engine block 12. A substantially similar second side cover (not shown) is operatively connected to a second side 24 (indicated in phantom) of the engine block 12. The side cover 18 has a first or inner layer 28 formed from an acoustic-absorbing material such as, but not limited to, polyurethane foam, melamine foam, fiberglass, or other known acoustic-absorbing materials. An “acoustic-absorbing material” is a material for which the ratio of the amplitude of the reflective sound wave to the amplitude of the incident sound wave is less than 1.0, as measured using standard measuring tests such as those according to ASTM (American Society for Testing and Materials) and SAE (Society of Automotive Engineers) standards. For example, ASTM E1050 is one test procedure for measuring absorption of an acoustic material. The amplitude of the wave incident on the material and the amplitude of the wave reflected on the material are measured at frequencies ranging from 0-20,000 Hertz. The ratio of reflected amplitude to incident amplitude is subtracted from 1. Absorption coefficients range from 0 to 1, with higher values being a more effective material.

The acoustic-absorbing material of the inner layer 28 is relatively compliant, and conforms to the outer surface 20 of the side 22 of engine block 12 when the side cover 18 is connected to the engine block 12. As shown, it is apparent that the inner layer 28 is a molded shape; however, the inner layer 28 may alternatively be a unitary substantially flat sheet, as its compliance will allow conformity to the irregular outer surface 20. Additionally, the inner layer 28 need not be coextensive with the outer shell layer 30. For example, the inner layer 28 may be a strip-like acoustic seal between the engine block 12 and the outer shell layer 30, located at all or most of the periphery of the surface of the outer shell layer facing the engine block 12. In such an embodiment, an air gap would exist between the engine block 12 and the outer shell layer 30 with the air gap bounded by the seal-like inner layer 28.

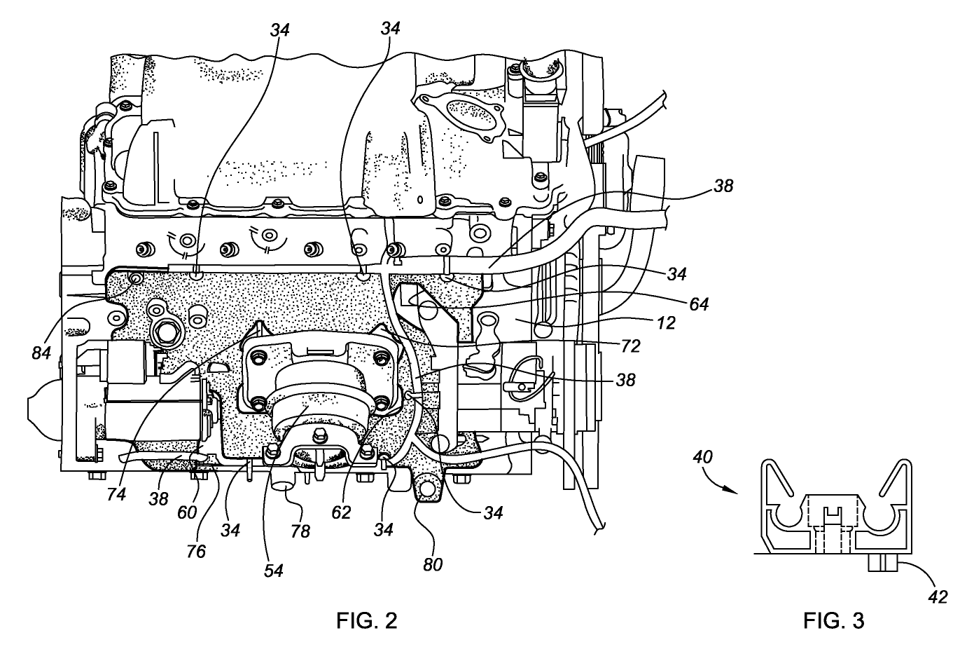

The first side cover 18 further includes a second or outer shell layer 30 molded from a substantially rigid, nonmetallic material, such as plastic, that establishes an acoustic barrier. An “acoustic barrier” is a material for which the ratio of amplitude of a sound wave transmitted through the material to the sound wave reflected off of the material is extremely low, for example, between 0 and 0.2. In the embodiment shown, the outer shell layer 30 is substantially coextensive with the inner layer 28. The outer shell layer 30 is operatively connected to the inner layer 28 by welding, bonding, positive attachment with well nuts, or any other suitable attachment mechanism, prior to connecting the side cover 18 to the engine block 12, as shown in FIG. 2. In FIG. 2, for ease of identification, the edges of side cover 18 are shown with heavier lines.

The outer shell layer 30 is formed with several features that permit the support of lightweight engine components, such as electrical wiring harnesses, electrical lines, and fuel or other fluid conduits, as described herein. For example, as is evident in FIG. 1, the outer shell layer 30 includes multiple side cover mounting bosses 32 configured with a small opening that is sufficient to secure a fastener that supports an engine conduit. For example, the side cover mounting bosses 32 have openings of approximately 3 millimeters in length that secure hook-type fasteners 34 as shown in FIG. 2. The hook-type fasteners 34 support a multi-branched wiring harness 38. Alternatively, the openings of the side cover mounting bosses 32 may support “Christmas tree”-type fasteners, such as the fastener 40 shown in FIG. 3, when a leg 42 of each fastener 40 is inserted into the opening of a respective molded mounting boss 32.

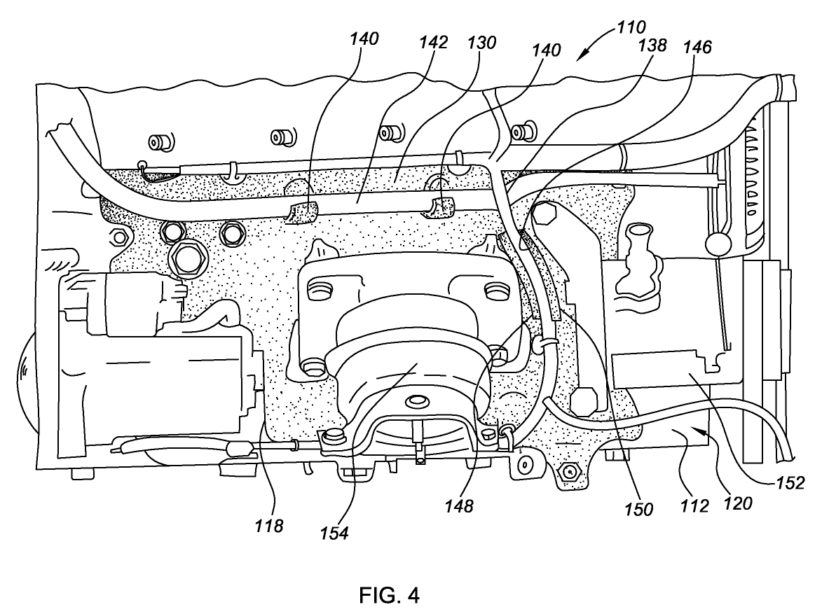

In another embodiment of an engine 110 shown in FIG. 4, a side cover 118 connected to an outer surface 120 of an engine block 112 includes an outer shell layer 130 with integrally formed fastener mounting brackets or clips 140 that support an engine conduit 142 (e.g., a hydraulic line) and that eliminate the need for separately-formed clips. Because the clips 140 are formed in the outer shell layer 130, engine bosses that would have otherwise been required for mounting and retaining separate fasteners are eliminated. Such engine bosses would typically have threaded holes for retaining fastener clips. Accordingly, overall engine mass and processing steps are reduced (e.g., no threading of the engine bosses is necessary). The side cover 118 also includes an inner acoustic layer, similar to inner layer 28 of FIG. 1, but not visible in FIG. 4 as the outer shell layer 130 is coextensive with the inner layer.

The side cover 118 of FIG. 4 is also formed with an integral support channel 146 defined by first and second protruding ridges 148, 150. The channel 146 is sized so that a portion of wiring harness 138 is secured in the channel 146 and guided appropriately around other engine components, such as air conditioning compressor 152 and engine mount and bracket assembly 154.

Referring again to FIG. 1, the outer shell layer 30 is formed with multiple openings or apertures 60, 62, 64, etc. The inner layer 28 is formed with substantially identical openings or apertures 66, 68, 70, etc. When connected with the engine block 12, as illustrated in FIG. 2, the openings 60, 62, 64 align with the openings 66, 68, 70 (not numbered in FIG. 2, but aligning directly under the openings 60, 62, 64, respectively. This allows engine bosses 72, 74 to extend through openings 62, 68 in order to allow mounting of the component 54 to the engine block 12. The other aligned openings 60, 66 and 64, 70 similarly allow connection of other engine components or conduits to the engine block 12.

Referring again to FIG. 1, the outer shell layer 30 is formed with apertures 76, 78, 80, 82, 84 that permit the outer layer 30 to be fastened to the engine block 12, as shown in FIG. 2, with the inner layer 28 sandwiched therebetween. Preferably, the fasteners used are isolation mounted, with a vibration-absorbing element, such as a dampening washer, between the outer layer 30 and the engine block 12.

Although not shown in the view of FIG. 1, the second side cover mounted to the second side 24 of the engine block 12 is substantially similar to the side cover 18, having an inner acoustic-absorbing layer and an outer shell layer that supports one or more engine conduits or components, but may have a slightly different configuration, such as a different placement of apertures to allow access for different engine components connected on the second side 24.

While the best modes for carrying out the invention have been described in detail, those familiar with the art to which this invention relates will recognize various alternative designs and embodiments for practicing the invention within the scope of the appended claims.

1. An apparatus for reducing noise of an engine that has an engine block with engine components operatively connected to the engine block, comprising:
a side cover configured to connect to a side of the engine block;
wherein the side cover has a first layer configured to be adjacent the outer surface of the side of the engine block when the side cover is connected to the engine block; wherein the first layer is a first acoustic-absorbing material;
wherein the side cover has a molded plastic, unitary, single-piece second layer configured to be adjacent to the first layer opposite the engine block; wherein the second layer is a second substantially rigid material establishing an acoustic barrier; wherein the molded plastic, unitary, single piece second layer is configured to operatively support at least one of the engine components to thereby operatively connect the at least one of the engine components to the engine block.

2. The apparatus of claim 1, wherein the at least one of the engine components is one of an electrical or fluid conduit; and wherein the second layer defines at least one of a boss configured for securing a fastener for the at least one of the engine components, a formed a fastener for the at least one of the engine components, and a channel for supporting and guiding the at least one of the engine components.

3. The apparatus of claim 2, wherein the second layer forms the fastener and the fastener is a hook-type fastener.

4. The apparatus of claim 1, wherein the engine block has bosses extending outward on the side of the engine; and wherein the first and second layers define apertures positioned to align with the engine bosses such that the engine bosses extend therethrough when the side cover is operatively connected to the engine block.

5. The apparatus of claim 1, wherein the first acoustic-absorbing material is one of polyurethane foam, fiberglass, and melamine foam.

6. The apparatus of claim 1, wherein the second layer is substantially coextensive with the first layer.

7. The apparatus of claim 1, wherein the second layer defines apertures configured to receive fasteners for isolation-mounting the second layer to the engine.

8. An apparatus for reducing noise of an engine that has an engine block having a side with an outer surface and with an engine component operatively connected to the engine block, comprising:
an inner compliant layer configured to be substantially conformable to the outer surface of the side of the engine block, wherein the inner compliant layer is an acoustic-absorbing material;
a substantially rigid outer shell layer substantially coextensive with the inner compliant layer and attachable thereto to establish an acoustic barrier with a ratio of amplitude of transmitted sound waves to amplitude of reflected sound waves of not greater than 0.2:1; and
wherein the outer shell layer is a unitary single piece defining a mounting bracket for the engine component, and a support channel for the engine component.

9. The apparatus of claim 8, wherein the outer shell layer defines apertures configured to receive fasteners for isolation-mounting the outer shell layer to the engine.

10. The apparatus of claim 8, wherein the inner compliant layer is one of polyurethane foam, fiberglass, and melamine foam.

11. An engine comprising:
an engine block having opposing sides and forming engine bosses;
multiple conduits operatively connected to the engine, each for providing one of electrical power and fluid to the engine;
a side cover operatively connected to one of the sides of the engine block for absorbing engine noise; wherein the side cover includes a first unitary layer of an acoustic-absorbing material conformed to an outer surface of one of the sides; wherein the first unitary layer defines apertures for the block bosses; wherein the side cover further includes a second unitary single-piece layer of a rigid, molded, non-metallic material forming fasteners for supporting at least one of the conduits and a channel for supporting at least another of the conduits; and wherein the second layer has additional apertures that align with the apertures of the first layer so that the engine bosses extend through the aligned apertures.

12. The engine of claim 11, wherein the acoustic-absorbing material of the first layer is one of polyurethane foam, fiberglass, and melamine foam.

13. The engine of claim 11, wherein the second unitary single-piece layer defines apertures configured to receive fasteners for isolation-mounting the second unitary single-piece layer to the engine.
